(19) United States
(12) Patent Application Publication
(10) Pub. No.: US 2023/0108602 A1
(43) Pub. Date: Apr. 6, 2023

(54) PREWASHING SYSTEM, PREWASHING METHOD, AND STORAGE MEDIUM

(71) Applicant: CONNECTED ROBOTICS, INC., Tokyo (JP)

(72) Inventors: Tetsuya SAWANOBORI, Tokyo (JP); Koichi TSUKAMOTO, Tokyo (JP)

(73) Assignee: CONNECTED ROBOTICS, INC., Koganei-shi, Tokyo (JP)

(21) Appl. No.: 17/956,520

(22) Filed: Sep. 29, 2022

(30) Foreign Application Priority Data
Oct. 5, 2021 (JP) 2021-164361

(51) Int. Cl. A47L 15/42; A47L 15/00; A47L 15/37; A47L 15/46; B25J 11/00

(52) U.S. Cl. CPC A47L 15/4295; A47L 15/0076; A47L 15/37; A47L 15/46; A47L 15/0021; B25J 11/0085; A47L 2401/04; A47L 2501/30

(57) ABSTRACT

A prewashing system includes a dish recognizing unit that recognizes a dish that is an object of prewashing executed prior to main washing, a first prewashing unit that performs prewashing of the dish that is the object of prewashing by a flow of water, a second prewashing unit that performs prewashing of the dish that is the object of prewashing by a washing tool, a prewashing method deciding unit that decides a prewashing method using at least one of the first prewashing unit and the second prewashing unit, on the basis of a form of the dish that is the object of prewashing, which is recognized by the dish recognizing unit, and a prewashing executing unit that executes prewashing of the dish that is the object of prewashing, by the prewashing method decided by the prewashing method deciding unit.

### CROSS-REFERENCE TO RELATED APPLICATIONS

This application is based upon and claims the benefit of priority under 35 USC 119 of Japanese Patent Application No. 2021-164361 filed on Oct. 5, 2021 the entire disclosure of which, including the description, claims, drawings, and abstract, is incorporated herein by reference in its entirety.

### BACKGROUND OF THE INVENTION

### Field of the Invention

The present invention relates to a prewashing system, a prewashing method, and a storage medium.

### Description of the Related Art

In recent years, dishwashers, which automatically wash dishes, have come into widespread use in establishments and so forth where food is prepared.

Dishwashers are a technology that is highly useful to such establishments, due to enabling staff for washing dishes to be reduced, and being capable of running regardless of the time of day.

### BRIEF SUMMARY OF THE INVENTION

A prewashing system for dishes according to an aspect of the present invention comprising:
an item recognizer that recognizes an item that is an object of prewashing executed prior to main washing;
a first prewasher that performs prewashing of the item that is the object of prewashing by a flow of water;
a second prewasher that performs prewashing of the item that is the object of prewashing by a washing tool;
a prewashing method decider that decides a prewashing method using at least one of the first prewasher and the second prewasher, on the basis of a form of the item that is the object of prewashing, which is recognized by the item recognizer; and
a prewashing executor that executes prewashing of the item that is the object of prewashing, by the prewashing method decided by the prewashing method decider.

### BRIEF DESCRIPTION OF THE SEVERAL VIEWS OF THE DRAWING

FIG. 1 is a schematic diagram illustrating an overall configuration of a prewashing system 1 according to the present invention.

FIG. 2 is a schematic diagram illustrating an example of an installation form of the prewashing system 1 according to the present invention.

FIG. 3 is a schematic diagram illustrating a hardware configuration of the control device 60.

FIG. 4 is a block diagram illustrating the functional configuration of the control device 60.

FIG. 5 is a flowchart showing a flow of dish data registration processing that the prewashing system 1 executes.

FIG. 6 is a flowchart showing a flow of prewashing processing that the prewashing system 1 executes.

FIG. 7 is a schematic diagram illustrating a configuration example of a hand according to a form that grips dishes by two fingers.

### DETAILED DESCRIPTION OF THE INVENTION

Embodiments of the present invention will be described below with reference to the drawings.

### First Embodiment

### [Configuration]

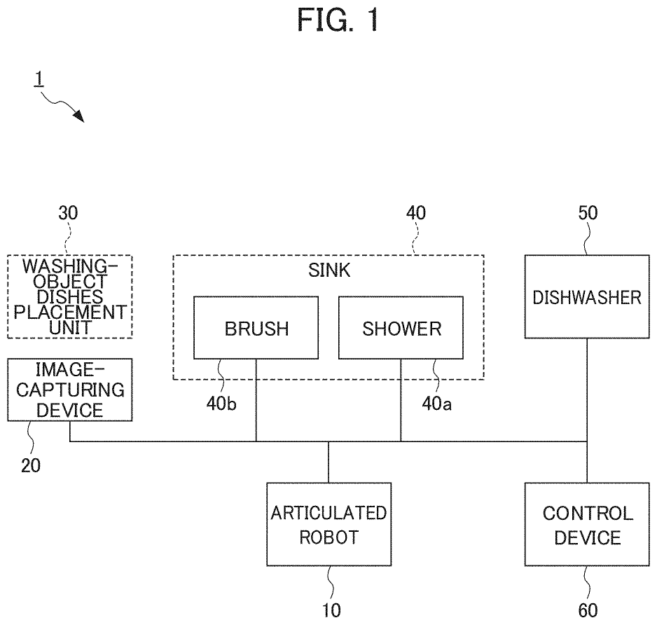

FIG. 1 is a schematic diagram illustrating an overall configuration of a prewashing system 1 according to the present invention.

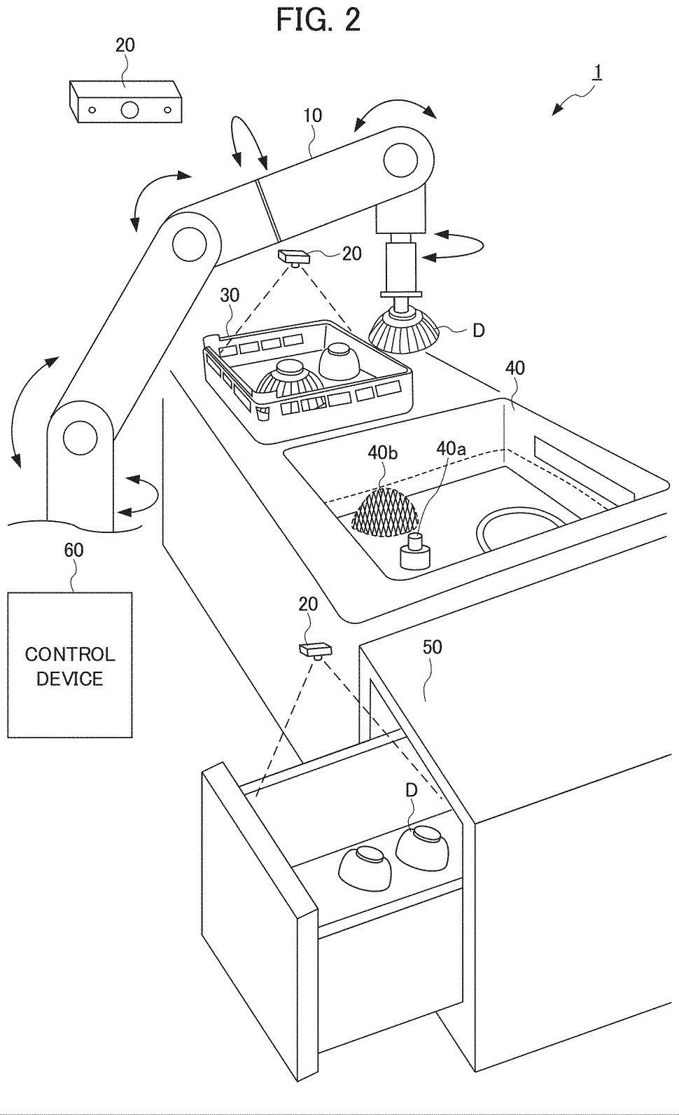

Also, FIG. 2 is a schematic diagram illustrating an example of an installation form of the prewashing system 1 according to the present invention.

As illustrated in FIGS. 1 and 2, the prewashing system 1 includes an articulated robot 10, an image-capturing device 20, a washing-object dishes placement unit 30, a sink 40, a dishwasher 50, and a control device 60. Also, components in the prewashing system 1 that are electrically controlled are configured to be communicable with the control device 60 through wired communication or wireless communication, and operate under the control of the control device 60. In this embodiment, a dish is an example of an item to be prewashed.

The articulated robot 10 is made up of a 6-axis vertical articulated robot or the like, for example, with a hand that is capable of vacuum suction of dishes D provided on a distal end of a robot arm. Also, the articulated robot 10 performs pickup of dishes D that are the object of prewashing from the washing-object dishes placement unit 30, and executes one of prewashing by flow of water and prewashing by brushing, in accordance with instructions from the control device 60. The articulated robot 10 then transports the dishes D following prewashing to a tray in the dishwasher 50, where the dishes D are released. Note that the image-capturing device 20 fixedly installed on a ceiling or the like, or the image-capturing device 20 installed at a distal end of the articulated robot 10 takes images of the vicinity of the hand of the articulated robot 10, and the positions of the dishes D and the positions of nearby objects and so forth are constantly recognized in the process from pickup to release of the dishes D.

The image-capturing device 20 is an image-capturing device that takes images of the operating range of the prewashing system 1 at predetermined time intervals (e.g., once a second), and has functions of acquiring visible light images and three dimensional shapes of the dishes D and so forth. For example, the image-capturing device 20 can be made up of an image-capturing system that has a digital camera and a three-dimensional scanner. Note that the image-capturing device 20 may be made up of a stereo camera system in which digital cameras are arrayed in parallel. In the present embodiment, a plurality of the image-capturing devices 20 are installed, with one of the image-capturing devices 20 installed above the washing-object dishes placement unit 30 (on the ceiling, a top face of a member covering the washing-object dishes placement unit 30, or the like), so as to take images of the entire washing-object dishes placement unit 30. Another one of the image-capturing devices 20 is installed above a rack of the dishwasher 50 on which dishes are placed, or a position where the tray for accommodating dishes conveyed to the dishwasher 50 is temporarily placed (on the ceiling, a nearby member, or the like), so as to take images of the entire rack or tray. Note that the image-capturing device 20 may be installed on the articulated robot 10, as described above, so as to take images of the vicinity of the hand of the articulated robot 10.

The washing-object dishes placement unit 30 is a region where used dishes D that are the object of washing are placed, and is installed at a position adjacent to the sink 40. In the present embodiment, the dishes D are arrayed on the washing-object dishes placement unit 30 in a face-down state (i.e., a state in which outer or bottom sides of the dishes D are visible as viewed from above). The outer or bottom sides of dishes D often have patterns or pictorial designs applied thereto, and accordingly simply arraying the dishes D in a face-down state can facilitate later-described recognition of the dishes D. However, if the dishes D can be recognized in a face-up state (i.e., a state in which inner or upper sides of the dishes D are visible as viewed from above), the dishes D may be arrayed on the washing-object dishes placement unit 30 in the face-up state, or irrespective of orientations of the dishes D.

The sink 40 is installed in a kitchen or the like of the establishment, provided with a vat in which water is stored, and a drain hole for draining water. In the present embodiment, a shower 40a for performing prewashing of the dishes D, and a brush 40b for brushing the dishes D, are installed in the sink 40.

The shower 40a includes a shower head that discharges an upward flow of water from a bottom side of the vat portion of the sink 40, and switches discharging and stopping of the flow of water in accordance with instructions of the control device 60, which will be described later. Hereinafter, prewashing by the flow of water from the shower 40a will be referred to as “first prewashing” as appropriate.

The brush 40b is a dishwashing tool that is made of a material such as nylon or the like, and performs brushing of the surfaces of the dishes D while deforming in accordance with the forms of the dishes D, by being pressed against the dishes D. Note that moisture is supplied to the brush 40b from therein, thereby enabling moisture to be applied to the surfaces of the dishes D. In the present embodiment, the brush 40b is capable of being rotated by a motor, and switches rotating and stopping in accordance with instructions of the control device 60, which will be described later. Hereinafter, prewashing by the brush 40b will be referred to as “second prewashing” as appropriate.

The dishwasher 50 is a device that automatically washes away soiling adhering to the dishes D, by operations such as spraying a flow of water containing detergent on the dishes D arrayed in a washing chamber, or the like. In the present embodiment, in addition to using a built-in configuration integrally assembled with the sink 40 for the dishwasher 50, a stationary type that is externally installable can be used as well. Note that the dishwasher 50 can be operated following control of the control device 60, and can also be operated by a worker operating the dishwasher 50.

The control device 60 is made up of an information processing device such as a personal computer (PC), a programmable controller, or the like, and controls the entire prewashing system 1 by executing various types of programs. For example, the control device 60 executes dish data registration processing for registering data of the dishes D in a database, and prewashing processing for performing prewashing of the dishes D. The control device 60 controls holding operations and conveying operations with respect to the dishes D that are performed by the articulated robot 10, and controls taking of images by the image-capturing device 20, by executing various types of programs. Also, the control device 60 controls discharging and stopping of the flow of water from the shower 40a in the sink 40, and controls rotation and stopping of the brush 40b.

### [Hardware Configuration of Control Device 60]

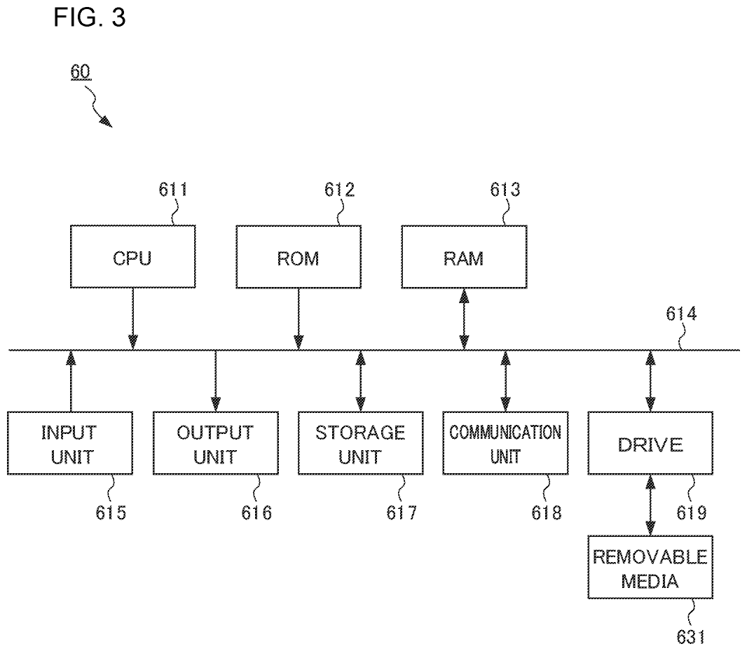

FIG. 3 is a schematic diagram illustrating a hardware configuration of the control device 60.

As illustrated in FIG. 3, the control device 60 includes a central processing unit (CPU) 611, read-only memory (ROM) 612, random-access memory (RAM) 613, a bus 614, an input unit 615, an output unit 616, a storage unit 617, a communication unit 618, and a drive 619.

The CPU 611 executes various types of processing following programs recorded in the ROM 612 or programs loaded to the RAM 613 from the storage unit 617.

The RAM 613 also stores data and so forth that is necessary for the CPU 611 to execute various types of processing, as appropriate.

The CPU 611, the ROM 612, and the RAM 613 are mutually connected via the bus 614. The input unit 615, the output unit 616, the storage unit 617, the communication unit 618, and the drive 619 are connected to the bus 614.

The input unit 615 includes an input device such as a mouse, a keyboard, or the like, and accepts input of various types of information directed to the control device 60. Note that a microphone may be included as the input unit 615, accepting input of various types of information by speech input by a worker.

The output unit 616 is made up of a display, a speaker, or the like, and outputs images or audio.

The storage unit 617 is made up of a hard disk, dynamic random-access memory (DRAM), or the like, and stores various types of data managed by various servers.

The communication unit 618 controls communication with other devices over a network.

A removable medium 631 such as a magnetic disk, an optical disc, a magneto-optical disk, semiconductor memory, or the like, is mounted to the drive 619 as appropriate. Programs read out from the removable medium 631 by the drive 619 are installed in the storage unit 617 as necessary.

Note that the above-described hardware configuration is a basic configuration of the control device 60, and that a configuration may be made in which part of the hardware is omitted, additional hardware is included, the form of implementation of the hardware is changed, or the like.

### [Functional Configuration]

Next, a functional configuration of the control device 60 will be described.

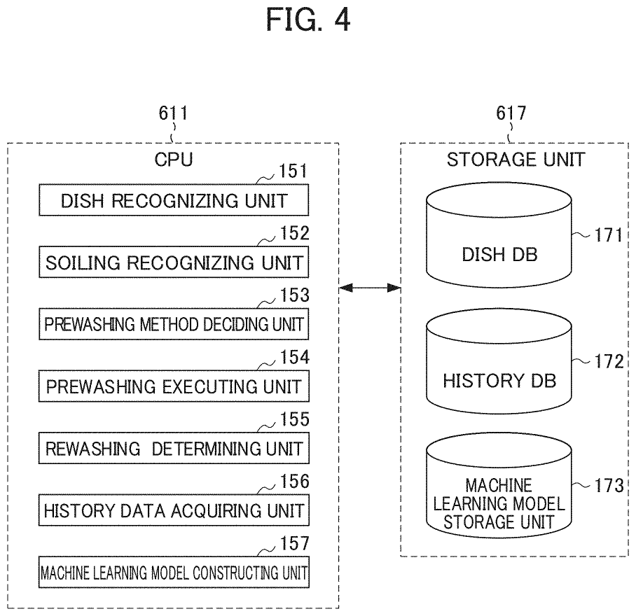

FIG. 4 is a block diagram illustrating the functional configuration of the control device 60.

As illustrated in FIG. 4, a dish recognizing unit 151, a soiling recognizing unit 152, a prewashing method deciding unit 153, a prewashing executing unit 154, a rewashing determining unit 155, history data acquiring unit 156, and a machine learning model constructing unit 157 function in the CPU 611 of the control device 60, by executing programs for dish data registration processing and prewashing processing. Also, the storage unit 617 forms a dish database (dish DB) 171, a history database (history DB) 172, and a machine learning model storage unit 173.

The dish DB 171 is a database storing data of dishes D that are the object of washing in the prewashing system 1. Data of the dishes D is acquired in advance at a timing of starting usage of these dishes D or the like, and data of images of the dishes D (RGB images or the like), three dimensional shapes, sizes, and so forth, is stored in the dish DB 171 in correlation with information identifying the dishes D (identification No. or the like). Note that at the time of acquiring data of the dishes D, the centers of gravity of the dishes D may be estimated as suction object positions, and stored together in the dish DB 171.

The history DB 172 is a database storing history data of states of the dishes D that are the object of prewashing prior to prewashing, and states thereof following prewashing and following main washing. For example, the history DB 172 can store data of visible light images and texture of the dishes D (three-dimensional forms of soiling on the surfaces of the dishes D, surface forms of the dishes D, and so forth) prior to prewashing, following prewashing, and following main washing, and determination results of whether or not rewashing was necessary following main washing. Such data can be used for updating a machine learning model to determine the states of soiling of the dishes D that are the object of washing.

The machine learning model storage unit 173 stores a machine learning model that has been constructed by machine learning in the prewashing system 1, in which data of clean states of the dishes D that are the object of washing and data of soiled state thereof are used as training data. In the present embodiment, the machine learning model stored in the machine learning model storage unit 173 is capable of performing inference in at least three stages of a clean state, lightly soiled state, and heavily soiled state with respect to the dishes D that are the object of washing. However, the number of stages of performing inference regarding the degree of soiling may be two stages (e.g., lightly soiled state and heavily soiled state), or four or more stages (e.g., broken down into four or more degrees of state of soiling). Note that the machine learning model stored in the machine learning model storage unit 173 can be sequentially updated by data of history acquired by the prewashing system 1 running.

On the basis of the image-taking results from the image-capturing device 20, the dish recognizing unit 151 recognizes the dishes D that are the object of washing in the prewashing system 1. Specifically, the dish recognizing unit 151 acquires visible light images of the inner or upper sides and outer or bottom sides of the dishes D, and data of the three dimensional forms of the dishes D, from the image-capturing device 20, in a state in which the dishes D that are the object of washing are clean (e.g., a state prior to starting usage). At this time, data of the sizes of the dishes D (diameter, height, and so forth) can be acquired from the data of the three-dimensional form of the dishes D. Also, the dishes D can be classified into groups in accordance with the types (e.g., groups such as plates, bowls, cups, and so forth), from the visible light images and the data of the three dimensional forms of the dishes D. Note that the centers of gravity of the dishes D may be estimated from the data of the three-dimensional form of the dishes D, as suction object positions for when the articulated robot 10 holds the dishes D. The dish recognizing unit 151 then stores the recognition results of the dishes D in the dish DB 171. Thus, the dishes D are registered in the dish DB 171. Note that when the dish recognizing unit 151 recognizes the dishes D, inference may be performed regarding which dish that a dish in an image is, using a machine learning model that has performed machine learning with various types of images of dishes D that are the object of recognition (images in which image-taking conditions such as direction of taking images, illumination, and so forth, are varied) as training data, and data of the dishes D may be acquired (by reading in catalog data or the like) on the basis of the results of the inference.

Also, at the time of performing prewashing of used dishes D, the dish recognizing unit 151 recognizes which dish out of the dishes D stored in the dish DB 171 that a dish in an image is, on the basis of the results of image-taking of the dish D by the image-capturing device 20 (visible light image and data of three-dimensional form). For example, the dish recognizing unit 151 matches the visible light image of the dishes D that is taken and data of three-dimensional form thereof with data of the various types of dishes stored in the dish DB 171, and determines a dish out of the data of the dishes stored in the dish DB 171 that has the highest agreement rate to be the dish D in the image. In this case as well, which dish D that the dish in the image is may be recognized using a machine learning model that has performed machine learning with various types of images of the dishes D that are the object of recognition (images in which image-taking conditions such as direction of taking images, illumination, and so forth, are varied) as training data.

Also, the dish recognizing unit 151 stores results of image-taking of used dishes D (dishes D prior to prewashing) by the image-capturing device 20 (visible light images and data of three-dimensional forms), as data representing samples of soiled dishes D, in the history DB 172. Data representing samples of soiled dishes D can be used for updating the machine learning model stored in the machine learning model storage unit 173.

The soiling recognizing unit 152 recognizes soiling of the dishes D that are the object of washing in the prewashing system 1, on the basis of image-taking results from the image-capturing device 20. In the present embodiment, the soiling recognizing unit 152 recognizes the degree of soiling of the dishes D that are the object of washing by a machine learning model stored in the machine learning model storage unit 173. That is to say, the soiling recognizing unit 152 inputs results of the image-capturing device 20 taking images of dishes D (visible light images and data of three-dimensional forms), performs inference by the machine learning model, and determines which state of a clean state, a lightly soiled state, and a heavily soiled state that the dishes D of which images are taken are in. At this time, a portion that is in a heavily soiled state may be identified from the entirety of one dish D. Also, the machine learning model used at this time may be a model that has performed learning using one element of color (color of soiling or the like) in images of the dishes D, and three-dimensional form (three-dimensional form of residue adhering to the surfaces of the dishes D or the like), or a combination thereof, as features. Also, inference may be performed with the degree of soiling in two stages, or four stages or more, as described earlier, and in this case, the prewashing method, the prewashing time, and so forth, can be set in accordance with the inferred degree of soiling.

The prewashing method deciding unit 153 decides the prewashing method on the basis of the types of dishes D that are the object of washing, and the results of recognition by the soiling recognizing unit 152.

As for a reference for deciding the prewashing method, various forms can be used in accordance with the objects, situations, and so forth, to which the prewashing system 1 is applied. As one example, the prewashing method can be decided on the basis of a reference relating to the color and texture of dishes D that are the object of prewashing. Texture can be defined as three-dimensional forms of the surfaces of dishes D that are the object of prewashing, for example, and three-dimensional forms of soiling on the surface of the dishes D and the surface forms of the dishes D are included here. In the present embodiment, the first prewashing (prewashing by flow of water) or the second prewashing (prewashing by brushing) is selected in accordance with the form of the dishes D that are the object of washing, and also, the second prewashing is selected in a case in which the degree of soiling is heavy. That is to say, out of dishes D regarding which the first prewashing is selected in accordance with the form of the dishes D that are the object of washing, the second prewashing (prewashing by brushing) is selected for the dishes D regarding which the soiling recognizing unit 152 has recognized that the degree of soiling is heavy.

That is to say, in the present embodiment, the second prewashing is selected for the dishes D that are the object of washing regarding which the forms thereof are classified for the second prewashing, and the dishes D regarding which the soiling recognizing unit 152 has recognized the state of soiling is heavy, and the first prewashing is selected for the other dishes.

Note however, that the ease of soiling adhering to the dishes D that are the object of washing may also be taken into consideration as a reference for selecting first prewashing (prewashing by flow of water) or second prewashing (prewashing by brushing), and selection of the first prewashing or the second prewashing may also be made with the material of the dishes D, the usage in which the dishes D are used, complexity in form, and so forth, as references. For example, the second prewashing may be selected for rice bowls, to which soiling such as rice and so forth readily adheres, while the first prewashing may be selected for drinking glasses to which only beverages such as water normally adhere. That is to say, selection of the first prewashing (prewashing by flow of water) or the second prewashing (prewashing by brushing) may be made not only with the recognition results of soiling as a reference, but also on the basis of recognition results of the dishes.

The prewashing executing unit 154 executes prewashing of the dishes D that are the object of washing by the method of prewashing decided by the prewashing method deciding unit 153. Specifically, in a case in which the prewashing method deciding unit 153 decides to execute the first prewashing regarding a particular dish D, the prewashing executing unit 154 causes a flow of water to be discharged from the shower 40a, and causes the articulated robot 10 holding the dish D that is the object of washing, to operate so as to place the dish D that is held (the inner side of the dish D) in the flow of water. Also, in a case in which the prewashing method deciding unit 153 decides to execute the second prewashing regarding a particular dish D, the prewashing executing unit 154 causes the brush 40b to rotate, and causes the articulated robot 10 holding the dish D that is the object of washing, to operate so as to place the dish D that is held (the inner side of the dish D) against the brush 40b. At this time, the prewashing executing unit 154 moves the dishes D such that the entire inner side of the dish D is evenly brought into contact with the brush 40b. Also, the prewashing executing unit 154 causes the articulated robot 10 to move the dish D in an opposite direction as to the rotation of the brush 40b, in order to increase friction between the brush 40b and the surface of the dish D. At this time, the amount of movement of the articulated robot 10 moving the dish D can be decided on the basis of the form of the dish D that is registered in the dish DB 171 or the form of the dish D that is recognized in real-time.

Now, the time over which the prewashing executing unit 154 executes prewashing, and the intensity of washing, are set in advance within a range in which effects of prewashing can be obtained. However, for dishes D regarding which determination is made by the rewashing determining unit 155 that rewashing is necessary, and prewashing is performed a second time or more, the settings of prewashing are changed such as setting a longer time, increasing the strength of the flow of water, brushing more strongly, or the like, to increase the effects of washing over those of the prewashing the previous time.

The rewashing determining unit 155 determines whether or not rewashing of dishes D is necessary, on the basis of the results of image-taking of the dishes D following completion of main washing by the image-capturing device 20. Specifically, the rewashing determining unit 155 performs inference of whether or not there is soiling on the dishes D following the main washing, by the machine learning model stored in the machine learning model storage unit 173, and in a case of inference that there is soiling on the dishes D, determines that rewashing of the dishes D is necessary. Note that the processing of inference regarding whether or not there is soiling on the dishes D using the machine learning model can be executed by procedures the same as those of the soiling recognizing unit 152.

The history data acquiring unit 156 acquires data of history of the state of the dishes D that are the object of prewashing, prior to prewashing, and the states following prewashing and following main washing. For example, the history data acquiring unit 156 acquires visible light images and data of texture (three-dimensional state of soiling on the surface of the dishes D and surface form of the dishes D) of the dishes D prior to prewashing, following prewashing, and following main washing, and also acquires data representing determination results regarding whether or not rewashing was necessary following the main washing, and stores these in the history DB 172 in a correlated manner.

The machine learning model constructing unit 157 constructs a machine learning model that takes data of a clean state and data of a soiled state of dishes D that are the object of washing in the prewashing system 1 as training data, and performs inference of whether input data (image-taking results of dishes D) represents a clean state or a soiled state. In the present embodiment, the machine learning model constructing unit 157 constructs a machine learning model that performs inference of input data, regarding which of at least three stages of a clean state, a lightly soiled state, and a heavily soiled state the input data indicates. Note that the machine learning model constructing unit 157 can sequentially update the machine learning model using data of history stored in the history DB 172.

As one example, the machine learning model constructing unit 157 can construct a machine learning model by performing machine learning of training data, in which colors in images of dishes D are features. In a case of using colors in images of dishes D as features, soiling can be detected by focusing on the color of the dishes D themselves and the colors of the soiling, for example. Also, the machine learning model constructing unit 157 can construct a machine learning model by performing machine learning of training data, in which the three-dimensional forms of the surfaces of the dishes D are features. In a case of using the three-dimensional forms of the surfaces of the dishes D as features, soiling can be detected by focusing on surface forms of residue such as grains of rice adhering to a smooth dish surface, for example. Note that a machine learning model can be constructed that is appropriate in accordance with objects, situations, and so forth in which the prewashing system 1 is applied, by taking both colors in images of the dishes D and the three-dimensional forms of the surfaces of the dishes D as features, or further including other variables in the features, and so forth.

### [Operations]

Next, operations of the prewashing system 1 will be described.

### [Dish Data Registration Processing]

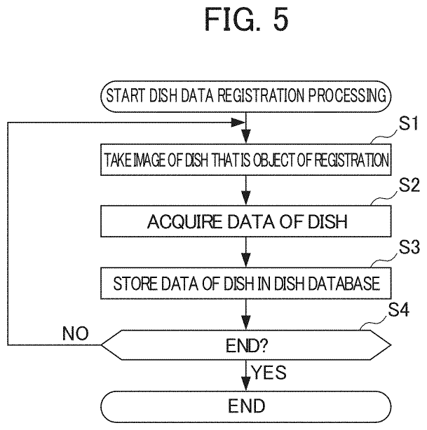

FIG. 5 is a flowchart showing a flow of dish data registration processing that the prewashing system 1 executes.

The dish data registration processing is started in accordance with an operation instructing execution of dish data registration processing being performed at the control device 60.

Upon the dish data registration processing being started, in step S1, the dish recognizing unit 151 takes images of a dish D that is an object of registration using the image-capturing device 20, and acquires data of image-taking results (visible light images and data of three-dimensional forms).

In step S2, the dish recognizing unit 151 acquires data of the dish D, including various types of data such as the size of the dish D, the type of the dish D, and so forth, from the data of image-taking results (visible light images and data of three-dimensional forms).

In step S3, the dish recognizing unit 151 correlates the data of the dish D that is acquired, and stores this data in the dish DB 171 in a manner correlated with identification information of the dish D.

In step S4, the dish recognizing unit 151 performs determination regarding whether or not processing has ended for all dishes D that are the object of registration.

In a case in which processing has not ended for all dishes D that are the object of registration, a determination of NO is made in step S4, and the processing transitions to step S1.

On the other hand, in a case in which processing has ended for all dishes D that are the object of registration, determination of YES is made in step S4, and the dish data registration processing ends.

### [Prewashing Processing]

Next, prewashing processing will be described.

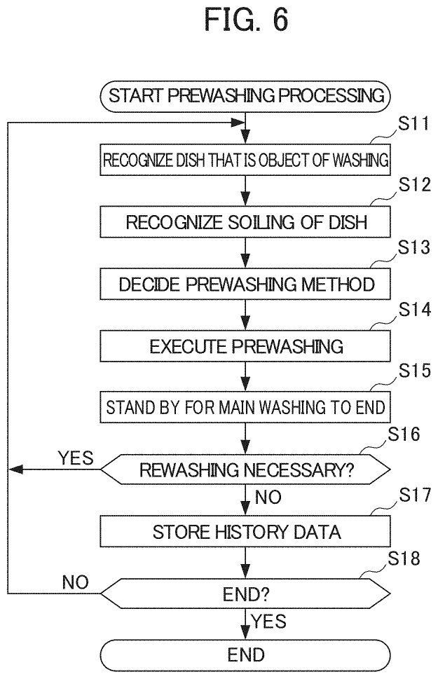

FIG. 6 is a flowchart showing a flow of prewashing processing that the prewashing system 1 executes.

The prewashing processing is started in accordance with an operation instructing execution of prewashing processing being performed at the control device 60.

Upon the prewashing processing being started, in step S11 the dish recognizing unit 151 takes images of the dish D that is the object of washing, using the image-capturing device 20, and recognizes which of the dishes registered in the dish DB 171 that the dish D that is the object of washing is, on the basis of the data of image-taking results (visible light images and data of three-dimensional forms).

In step S12, the soiling recognizing unit 152 recognizes soiling of the dish D that is the object of washing in the prewashing system 1, on the basis of image-taking results from the image-capturing device 20. At this time, the soiling recognizing unit 152 recognizes the degree of soiling of the dish D that is the object of washing (clean state, lightly soiled state, or heavily soiled state), by the machine learning model stored in the machine learning model storage unit 173.

In step S13, the prewashing method deciding unit 153 decides the prewashing method on the basis of the type of the dish D that is the object of washing, and the recognition results of the soiling recognizing unit 152. At this time, the prewashing method deciding unit 153 selects the second prewashing for dishes D that are the object of washing regarding which the forms thereof are classified for the second prewashing, and the dishes D regarding which the soiling recognizing unit 152 has recognized the state of soiling is heavy, and selects the first prewashing for other dishes.

In step S14, the prewashing executing unit 154 executes prewashing of the dish D that is the object of washing, in accordance with the prewashing method decided by the prewashing method deciding unit 153. That is to say, in a case in which the prewashing method deciding unit 153 decides to execute the first prewashing, the prewashing executing unit 154 causes a flow of water to be discharged from the shower 40a, and causes the articulated robot 10 holding the dish D that is the object of washing, to operate so as to place the dish D that is held (the inner side of the dish D) in the flow of water. Also, in a case in which the prewashing method deciding unit 153 decides to execute the second prewashing, the prewashing executing unit 154 causes the brush 40b to rotate, and causes the articulated robot 10 holding the dish D that is the object of washing, to operate so as to place the dish D that is held (the inner side of the dish D) against the brush 40b.

Following step S14, the dish D that is the object of washing is conveyed to the dishwasher 50 by the articulated robot 10, and main washing is performed.

In step S15, the prewashing system 1 stands by until main washing by the dishwasher 50 ends.

In step S16, the rewashing determining unit 155 performs determination regarding whether or not rewashing of the dishes D is necessary (whether or not there is soiling remaining on any of the dishes D), on the basis of results of the image-capturing device 20 taking images of each of the dishes D following completion of the main washing.

In a case in which rewashing of the dishes D is necessary, determination of YES is made in step S16, and the processing transitions to step S11. Thus, rewashing of the dishes D with soiling remaining is performed.

On the other hand, in a case in which rewashing of the dishes D is not necessary, determination of NO is made in step S16, and the processing transitions to step S17.

In step S17, the history data acquiring unit 156 stores data of history of the state prior to prewashing, the state following prewashing, and the state following main washing, that is acquired for the dish D that is the object of prewashing, in the history DB 172.

In step S18, the dish recognizing unit 151 performs determination regarding whether or not processing has ended for all dishes D that are the object of washing.

In a case in which processing has not ended for all dishes D that are the object of washing, a determination of NO is made in step S18, and the processing transitions to step S11.

On the other hand, in a case in which processing has ended for all dishes D that are the object of washing, determination of YES is made in step S18, and the prewashing processing ends.

As described above, the prewashing system 1 according to the present embodiment recognizes dishes D that are the object of prewashing, and decides which of the first prewashing by flow of water and the second prewashing by brushing to execute, on the basis of the types (form and so forth) of the dishes and the state of soiling (degree of soiling and so forth).

Accordingly, main washing can be executed following performing prewashing that is appropriate in accordance with the form of the dishes D that are the object of washing and the state of soiling at the time of washing.

Thus, when performing automatic washing of dishes, sufficient washing effects can be achieved in a surer manner.

Also, the prewashing system 1 according to the present embodiment stands by for main washing by the dishwasher 50 following performing prewashing of the dishes D by the prewashing method described above, determines whether or not rewashing of the dishes D is necessary, and in a case of determining that rewashing is necessary, executes washing of the dishes D from prewashing again.

Accordingly, soiling and so forth that is thought to be difficult to remove with the washing method of the main washing can be subjected to washing again by prewashing in which a washing method different from that of the main washing can be executed, and thereafter main washing can be executed again.

Thus, higher washing effects can be obtained as compared with a case of simply repeating the main washing for soiling that the main washing was not able to completely remove.

Also, the prewashing system 1 according to the present embodiment recognizes soiling of dishes D that are the object of washing, using a machine learning model constructed by machine learning in which data of a clean state and data of a soiled state of the dishes D that are the object of washing is used as training data.

Accordingly, even soiling on dishes having complicated patterns, dishes having complicated forms, and so forth, can be accurately inferred.

Thus, washing methods appropriate in accordance with soiling of each of the dishes can be selected.

### [Modification 1]

While the prewashing system 1 has been described in the above embodiment as constructing a machine learning model and recognizing soiled dishes by inference using the machine learning model, this is not restrictive.

For example, an arrangement may be made in which features for determining abnormalities from images of the dishes D taken by the image-capturing device 20 are calculated, and the images of the dishes D are analyzed using an abnormality sensing algorithm in which a determination reference is set for determining unsoiled dishes D as being normal and soiled dishes D as being abnormal, with respect to the features, thereby sensing adherence of soiling (abnormality).

In this case, soiling can be easily recognized regarding dishes D not registered in the dish DB 171 in advance, as well.

### [Modification 2]

While the articulated robot 10 has been described in the above embodiment as including a hand that is capable of vacuum suctioning of dishes, this is not restrictive. For example, a hand according to a form that grips dishes by a plurality of fingers may be installed in the articulated robot 10.

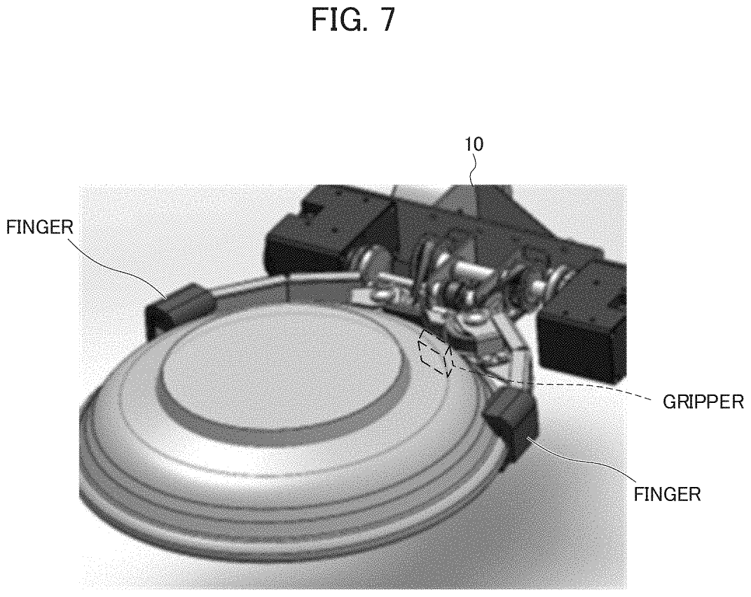

FIG. 7 is a schematic diagram illustrating a configuration example of a hand according to a form that grips dishes by two fingers. Note that FIG. 7 illustrates a configuration example supplementary provided with a gripper that supports dishes from the inner side, at an intermediate position between the two fingers.

As illustrated in FIG. 7, in a case of employing a form in which dishes are gripped by two fingers, even dishes with large recesses and protrusions on the surface, dishes with complicated forms, dishes that are large in size, and so forth, which are difficult to hold by vacuum suction, can be easily held. Also, in a case of gripping dishes by the hand according to the form illustrated in FIG. 7, the dishes can be vertically inverted by rotating the hand of the articulated robot 10. Accordingly, when placing dishes that are the object of washing on the washing-object dishes placement unit 30, workers can place the dishes in any orientation.

Also, an arrangement may be made in which the articulated robot 10 can automatically exchange a plurality of types of hands, such as a hand capable of vacuum suction, a hand according to a form that grips dishes by a plurality of fingers, and so forth, so as to hold dishes with hands suitable for the dishes that are the object of holding.

Note that the present invention is not limited to the above-described embodiment, and modifications, improvements, and so forth, can be carried out within a scope in which the advantages of the present invention can be obtained.

For example, while one of the first prewashing and the second prewashing is executed in the above embodiment, this is not restrictive. That is to say both the first prewashing and the second prewashing may be executed with respect to a single dish that is the object of washing.

Also, while actual dishes that are the object of washing are recognized as samples of soiled dishes in the above embodiment, this is not limited. That is to say, data representing samples of typical soiling (data of sample images representing types of soiling, or the like) may be acquired and used to recognize soiling of dishes.

As described above, the prewashing system 1 according to the present embodiment includes the articulated robot 10, the shower 40a, the brush 40b, and the control device 60. The control device 60 includes the dish recognizing unit 151, the prewashing method deciding unit 153, and the prewashing executing unit 154.

The dish recognizing unit 151 recognizes dishes that are the object of prewashing that is executed prior to main washing.

The shower 40a performs prewashing of the dishes that are the object of prewashing by a flow of water.

The brush 40b performs prewashing of the dishes that are the object of prewashing by a washing tool.

The prewashing method deciding unit 153 decides a prewashing method using at least one of the shower 40a and the brush 40b, on the basis of the forms of the dishes that are the object of prewashing, which are recognized by the dish recognizing unit 151.

The prewashing executing unit 154 executes prewashing of the dishes that are the object of prewashing by the prewashing method decided by the prewashing method deciding unit 153.

Accordingly, main washing can be executed following performing prewashing that is appropriate in accordance with the form of the dishes that are the object of washing.

Thus, when performing automatic washing of dishes, sufficient washing effects can be achieved in a surer manner.

The prewashing method deciding unit 153 decides a prewashing method using one of the shower 40a and the brush 40b, on the basis of at least one of the color and the texture of the dishes that are the object of prewashing.

Accordingly, an appropriate prewashing method can be decided on the basis of the color or surface form of dishes, in addition to the form of the dishes.

The prewashing system 1 includes the soiling recognizing unit 152.

The soiling recognizing unit 152 recognizes the state of soiling of dishes.

The prewashing method deciding unit 153 decides which of the shower 40a and the brush 40b that the prewashing method will use, on the basis of the form of the dishes that are the object of prewashing, and the state of soiling.

Accordingly, main washing can be executed following performing prewashing that is appropriate in accordance with the form of the dishes that are the object of washing and the state of soiling at the time of washing.

Following main washing that is executed following the prewashing, the soiling recognizing unit 152 recognizes the state of soiling of the washed dishes.

In a case in which the soiling recognizing unit 152 recognizes that there is soiling remaining on the washed dishes, the prewashing executing unit 154 executes prewashing of the dishes again.

Accordingly, soiling and so forth that is thought to be difficult to remove with the washing method of the main washing can be subjected to washing again by prewashing in which a washing method different from that of the main washing can be executed, and thereafter main washing can be executed again.

In a case of executing prewashing of the dishes again, the prewashing executing unit 154 executes the prewashing for a longer washing time than the prewashing the previous time.

Accordingly, the effects of washing can be improved over the prewashing the previous time, and thus the dishes can be washed in a surer manner.

The soiling recognizing unit 152 recognizes the state of soiling of the dishes on the basis of a machine learning model that has performed machine learning of images of dishes with soiling adhered thereto.

Accordingly, even soiling on dishes having complicated patterns, dishes having complicated forms, and so forth, can be accurately inferred.

The soiling recognizing unit 152 recognizes the state of soiling of the dishes by analyzing images of dishes that are the object of prewashing using an abnormality sensing algorithm.

Accordingly, soiling can be easily recognized regarding dishes not registered in the dish DB 171 in advance, as well.

The prewashing executing unit 154 holds the dishes that are the object of prewashing, and moves the dishes that are the object of prewashing such that the washing tool comes into contact with the entire face of the inside thereof.

Accordingly, the dishes and the washing tool can be brought into appropriate contact, by moving the dishes in accordance with the shapes thereof, and so forth.

The prewashing executing unit 154 includes a robot arm that holds dishes that are the object of prewashing, and executes prewashing by moving the dishes that are the object of prewashing, using the robot arm.

Accordingly, the dishes can be held in a flexible orientation, and the dishes and the washing tool can be appropriately brought into contact.

The brush 40b performs prewashing of the dishes by a rotating washing tool.

Accordingly, prewashing can be effectively performed, and also the washing effects of prewashing can be improved.

The prewashing system 1 includes the dish DB 171.

The dish DB 171 stores data including forms of the dishes that are the object of prewashing in a clean state.

The prewashing executing unit 154 acquires data of dishes that are the object of prewashing, recognized by the dish recognizing unit 151, from the dish DB 171, and decides which of the shower 40a and the brush 40b that the prewashing method will use, on the basis of the acquired data of the dishes that are the object of prewashing.

Accordingly, the prewashing method can be decided on the basis of accurate data indicating the dishes that are the object of washing, and thus the prewashing method can be selected more appropriately.

The present invention can be carried out combining examples described in the above embodiment as appropriate.

The processing sequence described above can be executed by hardware, and can also be executed by software.

In other words, the functional configuration in FIG. 4 is only exemplary, and is not restrictive in particular. That is to say, it is sufficient for the prewashing system 1 to be provided with functions that can execute the entirety of the above-described series of processing, and what sort of functional blocks are to be used for realizing these functions are not limited in particular to the example in FIG. 4.

A single functional block may be configured by a single piece of hardware, a single installation of software, or a combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium storing the program is made up of removable media that is distributed separately from the apparatus main unit, or storage media or the like that is built into the apparatus main unit in advance. Examples of the removable media include magnetic disks, optical discs, magneto-optical disks, flash memory, and so forth. Examples of optical disks include compact disc read-only memory (CD-ROM), Digital Versatile Discs (DVD), Blu-ray discs (registered trademark), and so forth. Examples of magneto-optical disks include MiniDiscs (MD) and so forth. Examples of flash memory include Universal Serial Bus (USB) memory and Secure Digital (SD) cards. Also, examples of storage media built into the apparatus main unit in advance include ROM, hard disks, and so forth, in which programs are stored.

It should be noted that, in the present specification, the steps describing the program recorded in the storage medium include not only the processing executed in a time series following this order, but also processing executed in parallel or individually, which is not necessarily executed in a time series.

Further, in the present specification, the terminology of the system means an entire apparatus including a plurality of apparatuses and a plurality of units.

What is claimed is:

1. A prewashing system for dishes, comprising:
an item recognizer that recognizes an item that is an object of prewashing executed prior to main washing;
a first prewasher that performs prewashing of the item that is the object of prewashing by a flow of water;
a second prewasher that performs prewashing of the item that is the object of prewashing by a washing tool;
a prewashing method decider that decides a prewashing method using at least one of the first prewasher and the second prewasher, on the basis of a form of the item that is the object of prewashing, which is recognized by the item recognizer; and
a prewashing executor that executes prewashing of the item that is the object of prewashing, by the prewashing method decided by the prewashing method decider.

2. The prewashing system for dishes according to claim 1, wherein
the prewashing method decider decides a prewashing method using one of the first prewasher and the second prewasher, on the basis of at least one of color and texture of the item that is the object of prewashing.

3. The prewashing system for dishes according to claim 1, further comprising:
a soiling recognizer that recognizes a state of soiling of the item,
the prewashing method decider decides which of the first prewasher and the second prewasher that the prewashing method will use, on the basis of the form of the item that is the object of prewashing, and the state of soiling.

4. The prewashing system for dishes according to claim 3, wherein
following main washing that is executed following the prewashing, the soiling recognizer recognizes the state of soiling of the washed item, and
in a case in which the soiling recognizer recognizes that there is soiling remaining on the washed item, the prewashing executor executes prewashing of the item again.

5. The prewashing system for dishes according to claim 3, wherein
in a case of executing prewashing of the item again, the prewashing executor executes the prewashing for a longer washing time than the prewashing a previous time.

6. The prewashing system for dishes according to claim 3, wherein
the soiling recognizer recognizes the state of soiling of the item on the basis of a machine learning model that has performed machine learning of images of items with soiling adhered thereto.

7. The prewashing system for dishes according to claim 3, wherein
the soiling recognizer recognizes the state of soiling of the items by analyzing an image of the item that is the object of prewashing using an abnormality sensing algorithm.

8. The prewashing system for dishes according to claim 1, wherein
the prewashing executor holds the item that is the object of prewashing, and moves the item that is the object of prewashing with the washing tool coming into contact with an entire face of an inside thereof.

9. The prewashing system for dishes according to claim 1, wherein
the prewashing executor includes a robot arm that holds the item that is the object of prewashing, and executes the prewashing by moving the item that is the object of prewashing, using the robot arm.

10. The prewashing system for dishes according to claim 1, wherein
the second prewasher performs prewashing of the items by the washing tool that rotates.

11. The prewashing system for dishes according to claim 1, further comprising:
an item database that stores data including the form of the item that is the object of prewashing in a clean state, wherein
the prewashing method decider acquires data of the item that is the object of prewashing, recognized by the item recognizer, from the item database, and decides which of the first prewasher and the second prewasher that the prewashing method will use, on the basis of the acquired data of the item that is the object of prewashing.

12. A prewashing method executed by a prewashing system for dishes, comprising:
item recognizing an item that is an object of prewashing executed prior to main washing;
first prewashing of the item that is the object of prewashing by a flow of water;
second prewashing of the item that is the object of prewashing by a washing tool;
prewashing method deciding a prewashing method including at least one of the first prewashing and the second prewashing, on the basis of a form of the item that is the object of prewashing, which is recognized in the item recognizing; and
prewashing executing prewashing of the item that is the object of prewashing, by the prewashing method decided in the prewashing method deciding.

13. A non-transitory storage medium storing a program that causes a computer that controls a prewashing system for dishes including
a first prewasher that performs prewashing of an item that is an object of prewashing, executed prior to main washing, by a flow of water, and
a second prewasher that performs prewashing of the item that is the object of prewashing by a washing tool, to execute:
item recognizing processing of recognizing the item that is the object of prewashing;
prewashing method deciding processing of deciding a prewashing method using at least one of the first prewasher and the second prewasher, on the basis of a form of the item that is the object of prewashing, which is recognized by the item recognizing processing; and
prewashing executing processing of executing prewashing of the item that is the object of prewashing, by the prewashing method decided by the prewashing method deciding processing.
